(19) United States
(12) Patent Application Publication
(10) Pub. No.: US 2022/0225824 A1
(43) Pub. Date: Jul. 21, 2022

(54) KIT FOR OUTDOOR COOKING

(71) Applicant: Pacalito Ltd., Petach Tikva (IL)

(72) Inventor: Nitay Glassman, Nahalal (IL)

(21) Appl. No.: 17/611,934

(22) PCT Filed: May 18, 2020
(86) PCT No.: PCT/IL2020/050541

§ 371 Date: Nov. 17, 2021

Related U.S. Application Data
(60) Provisional application No. 62/849,921, filed on May 19, 2019.

(51) Int. Cl. A47J 36/26; F24C 15/28

(52) U.S. Cl. CPC A47J 36/26; F24C 15/28

(57) ABSTRACT

A cooking kit comprising a cooking pot; a cup adapted to be assembled as a cap on an opening of the pot, wherein when assembled the cup and the pot form a container adapted to contain additional cooking equipment; a windscreen with adjustable diameter; and a support element connectable to the windscreen, wherein the pot is adapted to be inserted within the windscreen so that a bottom of the pot is put on the support element, wherein the support element is designated to maintain a desired constant distance between a burner positioned beneath the cooking pot and the bottom of the pot.

### TECHNICAL FIELD

The present disclosure generally relates to cooking equipment, and particularly for equipment suitable for outdoor cooking.

### BACKGROUND

People who spend time outside such as, for example, hikers, bikers, campers and outdoor workers, may want to cook and/or heat from time to time hot beverages, soups, noodles and/or any other suitable foods or beverages. In order to be able to cook, eat and drink, they usually carry at least one pot for cooking, cups, mugs and/or bowls according to the need, spoons and other cutlery, and some sort of a portable stove. A portable stove usually includes a burner and a fuel container, and requires a gas cartridge, liquid fuel and/or alcohol. Overall, outdoor cooking usually requires heavy and cumbersome equipment that takes a lot of space.

Additionally, users may face problems in the field conditions such as strong wind that extinguishes the fire, hardship with removing cooked goods from the hot fire, no clean place to the put a stirring spoon used while cooking, etc. Therefore, cooking in outdoor conditions may require adjustments, which are sometimes improvised in real time with objects existing in the field or pre-packed equipment. Usually, experienced outdoor people have various methods to deal with the field conditions. There are some products designated for solving some of the problems that may occur, such as foldable windscreens to block the wind from extinguishing the fire.

Some kit products exist, which usually include a portable stove, cups, a fuel container, and sometimes additional equipment, organized in a case. However, these may be quite cumbersome and large. In addition, people need to carry the required ingredients such as coffee, tea, sugar, food to be cooked and/or heated, etc. Usually, outdoor people want to keep their carried equipment as lightweight and as small as possible.

### SUMMARY

Some embodiments of the present disclosure provide a cooking kit comprising: a cooking pot; a cup adapted to be assembled as a cap on an opening of the pot, wherein when assembled the cup and the pot form a container adapted to contain additional cooking equipment; a windscreen with adjustable diameter; and a support element connectable to the windscreen, wherein the pot is adapted to be inserted within the windscreen so that a bottom of the pot is put on the support element, wherein the support element is designated to maintain a desired constant distance between a burner positioned beneath the cooking pot and the bottom of the pot.

Optionally, when the kit is in a cooking state, the windscreen is configured to maintain heat in a gap between the windscreen and the pot along the entire height and circumference of the pot, wherein an air exit opening at the top of the gap is smaller than an air suction opening at the bottom of the gap.

Optionally, the cooking pot has a collapsible handle, the handle is rotatable about a pivot connection from a collapsed state to an elevated state.

Optionally, the pot comprises a fastener catch, the handle comprises a latch, and wherein the handle is elevated, the catch in adapted to keep the handle in elevated state by holding the latch.

Optionally, a length of an extended portion of the handle is such that, when the handle is in collapsed position, a distal end does not extend beyond the bottom of the pot in the longitudinal direction of the extended portion.

Optionally, the cup comprises at least one recess along its circumference, the at least one recess matches other pieces of equipment included in the kit when packed together with the cup.

Optionally, the at least one recess matches match legs of a windscreen when packed together with the cup.

Optionally, the windscreen comprises a size-adjusting mechanism adapted for reducing and enlarging the size of the windscreen as required.

Optionally, the size-adjusting mechanism comprises a plurality of straps extending from the windscreen and corresponding slits in the windscreen.

Optionally, the pot support includes at least two prongs, wherein the windscreen comprises holes adapted for insertion of each prong from one side of the windscreen and exit of a distal end of the prong from another side of the windscreen.

Optionally, the windscreen includes at least four holes for insertion and exit of the prongs.

Optionally, the pot is adapted to be inserted within the windscreen so that a bottom of the pot is put on the pot support prongs, wherein a burner is insertable below the pot support prongs and the locations of the holes along the windscreen is designated to maintain a desired constant distance between the burner and the bottom of the pot.

Optionally, the pot comprises a non-projecting indention at the opening of the pot.

Optionally, the cup is adapted to contain a stove burner when the cup is assembled on the pot.

Optionally, the kit includes at least two additional cups adapted to be attached at their openings and to form a container when attached, the formed container is insertable into the pot.

Optionally, the kit includes at least one ingredients container, adapted to be packed in the container formed by the additional cups.

Optionally, the kit includes a kit holder configured to fit tightly on an assembly of the pot, the cup and the windscreen in a packed state, the holder is configured to be installed on the pot as a pot carrier handle.

Optionally, the kit holder comprises a handhold at a top stripe portion having a length fitting closely to the diameter of the cup, at least two elongated arms extending perpendicularly from the top stripe, each arm comprising a bottom latch at its distal end, the bottom latches are inwardly extending towards each other.

Optionally, the pot includes slots, into which the latches are insertable, enabling the kit holder to be used to carry the pot.

Optionally, the arms of the kit holder have a length suitable for tightly fitting on the assembly when the kit is in its packed state, so that the latches fit tightly at the bottom of the pot and do not extend further beyond the bottom of the pot when the kit is in its packed state.

Optionally, the pot is made of 1100 aluminum alloy or titanium, and wherein the pot has a thickness of between 0.7 to 1.3 millimeters.

Optionally, the windscreen is made of thin springy steel of between 0.2 to 0.3 millimeters.

Optionally, the total weight of the kit is smaller than 1000 grams.

Optionally, the total weight of the kit is about 500 grams.

### BRIEF DESCRIPTION OF THE DRAWINGS

Some non-limiting exemplary embodiments or features of the disclosed subject matter are illustrated in the following drawings:

FIGS. 1A and 1B are schematic illustrations of perspective and top external views of a cooking kit in its packed state, according to some embodiments of the present disclosure;

FIGS. 2A and 2B are schematic illustrations of perspective and top external views, respectively, of a cooking kit in its cooking state, according to some embodiments of the present disclosure;

FIGS. 3A, 3B, 3C and 3D are schematic illustrations of side views and cross-sectional views of a cooking kit in its packed state, according to some embodiments of the present disclosure;

FIGS. 4A, 4B, 4C and 4D are schematic illustrations of side views and cross-sectional views of a cooking kit in its cooking state, according to some embodiments of the present disclosure;

FIGS. 5A, 5B, 5C and 5D are schematic illustrations of perspective, lateral and top external views of the cooking kit in its packed state, according to some embodiments of the present disclosure; and

FIGS. 6A, 6B, 6C and 6D are schematic illustrations of perspective, lateral and top external views of the cooking kit in its cooking state, according to some embodiments of the present disclosure.

With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described. References to previously presented elements are implied without necessarily further citing the drawing or description in which they appear.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

### DETAILED DESCRIPTION

Before explaining at least one embodiment of the invention in detail in this disclosure, it is to be understood that the disclosure is not necessarily limited in its application to the details of construction and the arrangement of the components and/or methods set forth in the following description and/or illustrated in the drawings and/or the Examples. The disclosure is capable of other embodiments or of being practiced or carried out in various ways.

Some embodiments of the present disclosure provide a kit and method for outdoor cooking, including especially designed cooking equipment enabling compact and light-weight packaging. In some embodiments, the kit includes cups for consuming the cooked beverages and/or foods. In some embodiments, the kit includes containers for storage of ingredients required for cooking a food or a beverage. In some embodiments, the kit includes containers for storage of fuel or alcohol. In some embodiments, the kit includes a collapsible windscreen and/or other solutions for outdoor cooking.

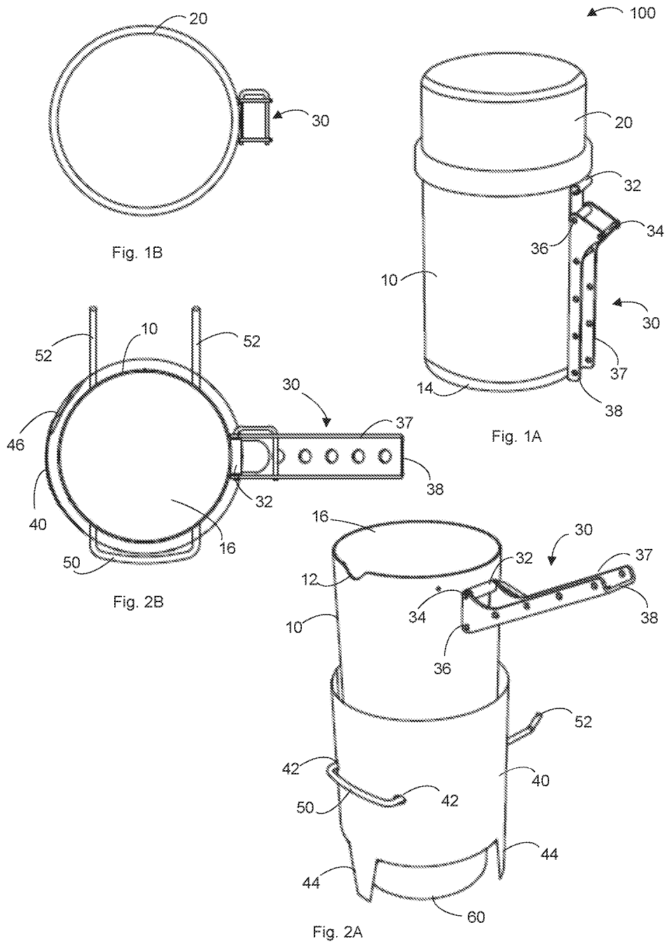

Reference is now made to FIGS. 1A and 1B, which are schematic illustrations of perspective and top external views of a cooking kit 100 in its packed state, according to some embodiments of the present disclosure. Cooking kit 100 may include a cooking pot 10, a cup 20, and a collapsible handle 30. In its packed state, pot 10 may be used as a container of kit 100 and cup 20 may be used as a cap, for example, on top of pot 10, wherein other cooking equipment of kit 100 is packaged inside pot 10 and/or cup 20, as described in more detail herein below. Pot 10 may have a bottom 14, for example on a side of pot 14 distant from cup 20 when kit 100 in its packed state.

FIGS. 1A and 1B shows handle 30 in its collapsed state. Handle 30 may be pivotally connected to pot 10, for example by an axle, a hinge, and/or any other suitable pivot connector 36. For example, handle 30 may rotate about pivot connector 36 between the collapsed state shown in FIGS. 1A and 1B and an elevated state as described in more detail herein below. Pot 10 and/or handle 30 may further include a fastener catch 32 and/or a matching latch 34. When handle 30 is elevated, handle 30 may be kept by catch 32 in elevated state. For example, latch 34 may be catched by catch 32 to keep handle 30 in elevated position. For example, latch 34 may include a rod which may snap into catch 32 when pressed into catch 32. Other fastening methods are possible in order to keep handle 30 elevated when moved into elevated position and/or pressed towards pot 10 and/or catch 32.

Handle 30 may include an extended portion 37, adapted for holding pot 10 by it, when handle 30 is in its elevated state. It will be appreciated that in some embodiments, the length of portion 37 is such that, when handle 30 is in collapsed position, a distal end 38 of portion 37 does not extend beyond bottom 14 in the longitudinal direction of extended portion 37.

It will be appreciated that although FIGS. 1A and 1B show cup 20 and pot 10 that have a generally circular cross-section, cup 20 and/or pot 10 may have any other suitable shape.

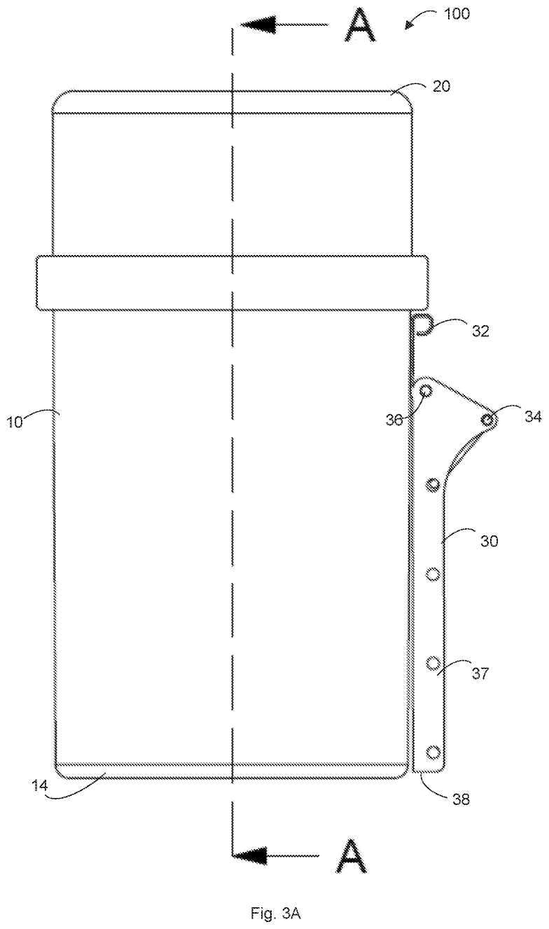

Reference is now made to FIGS. 2A and 2B, which are schematic illustrations of perspective and top external views, respectively, of a cooking kit 100 in its cooking state, according to some embodiments of the present disclosure. For example, after cup 20 was removed from pot 10 and/or other equipment was removed from within pot 10 and/or other operations was performed as described in more detail herein below. Kit 100 may include a windscreen 40 and a pot support 50.

Windscreen 40 may be a tube-shaped object with adjustable diameter, as described in more detain herein below. For example, windscreen 40 may include a diameter-adjusting mechanism 46. In some embodiments of the present disclosure, the diameter of windscreen 40 may be reduced, for example when kit 100 is in its packed state, for example to fit closely around the external diameter of pot 10. The diameter of windscreen 40 may be enlarged, for example, to enable comfortable insertion of a stove burner 60 below pot 10 for cooking, for example without windscreen 40 touching burner 60 and/or pot 10 while burner 60 is operating. Pot support 50 may be fork-shaped and/or u-shaped, with at least two prongs 52. Prongs 52 may be inserted in corresponding holes 42 that enable, for example, insertion of each prong 52 from one side of windscreen 40 and exit of a distal end of prong 52 from another side of windscreen 40. Accordingly, for example, windscreen 40 may include at least four holes 42, two for insertion and two for exit.

During operation, pot 10 may be put within windscreen 40 and/or bottom 14 of pot 10 may be put on top of pot support 50, for example supported by prongs 52. Burner 60 may be put within windscreen 40 and/or below pot support 50 and/or bottom 14 of pot 10. Windscreen 40 may include legs 44, for example at least three legs 44 that may enable stable positioning of windscreen 40 on top of a ground, a table or any other suitable surface. The locations of holes 42 along windscreen 40 may be designated to facilitate and/or maintain a desired constant distance between burner 60 and bottom 14 of pot 10, when bottom 14 is on top of pot support 50 and burner 60 is below pot support 50. In some embodiments, legs 44 include a folding mechanism and/or can be folded.

FIGS. 2A and 2B show handle 30 in an elevated state, for example after handle 30 was rotated to an elevated position, about pivot connector 36. Latch 34 may be held by catch 42 to keep handle 30 in elevated position. In this position, a user may hold handle 30 and/or move pot 10 by holding it from handle 30. In some embodiments, it may be preferable to have extended portion 37 as long as possible, in order to enable a user to move pot 10 without being damaged by heat provided by burner 60. However, in order to keep kit 100 compact in its packed state shown in FIG. 1A, when handle 30 is in collapsed position, a distal end 38 of portion 37 may not extend beyond bottom 14 in the longitudinal direction of extended portion 37.

Pot 10 may include an opening 16 by which ingredients, foods, drinks, liquids, and/or components of kit 100 may be inserted into pot 10 and removed from pot 10. Opening 16 may include an indentation 12, for example to facilitate pouring of contents of pot 10 from pot 10, for example without having a projecting spout. In some embodiments, pot 10 may not include a spout that projects outwardly from the edge of pot 10, for example in order to enable the compact packing of kit 100 and/or assembling of cup 20 on pot 10.

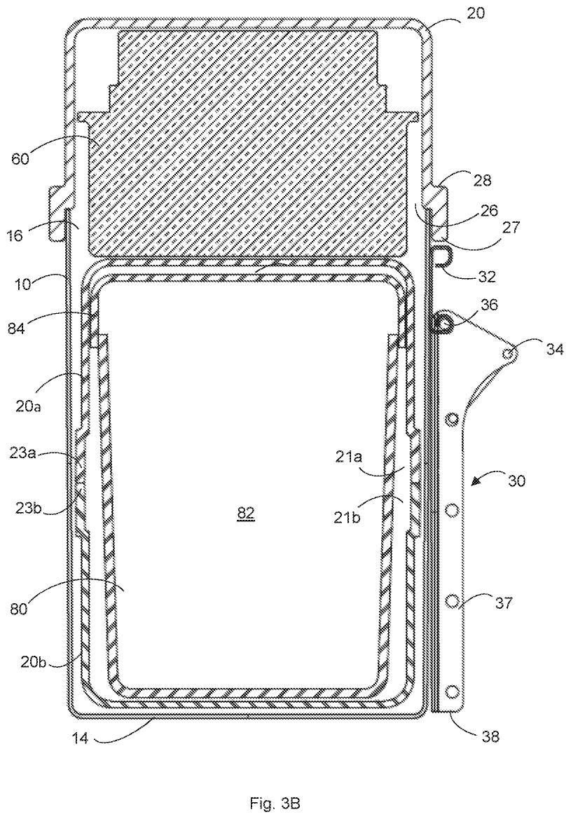

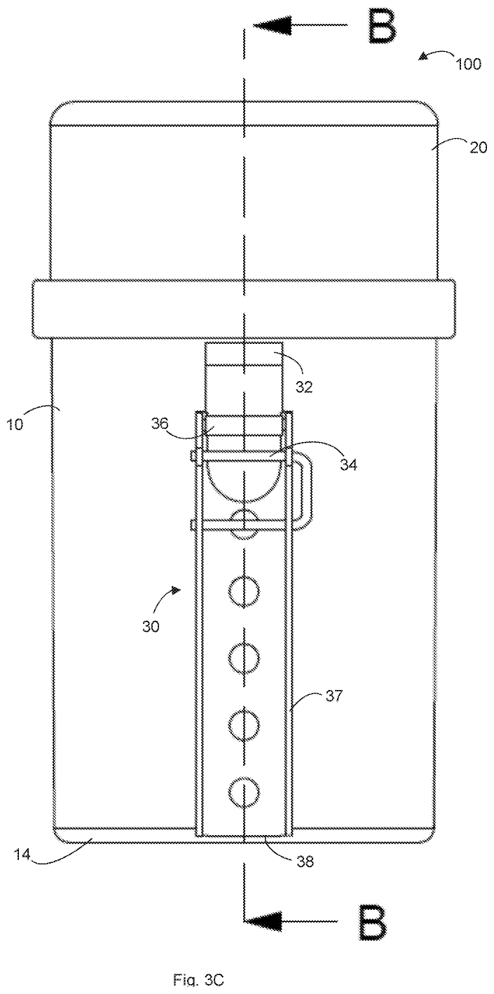

Reference is now made to FIGS. 3A, 3B, 3C and 3D, which are schematic illustrations of side views and cross-sectional views of cooking kit 100 in its packed state, according to some embodiments of the present disclosure. FIG. 3B shows the cross-section A-A of kit 100 along line A-A shown in FIG. 3A. FIG. 3D shows the cross-section B-B of kit 100 along line B-B shown in FIG. 3C. In some embodiments, in its packed state, kit 100 may include stove burner 60, an ingredient container 80 and/or cups 20a and/or 20b, in addition to pot 10, cup 20, and/or handle 30. For example, stove burner 60, an ingredient container 80 and/or cups 20a and/or 20b may be packed inside pot 10 and/or cup 20, for example when cup 20 is assembled on pot 10. In some embodiments, stove burner 60 may also include a fuel container (not shown).

For example, an opening 26 of cup 20 may fit onto opening 16 of pot 10. For example, an edge 27 of opening 26 may have a shape that matches opening 16 of pot 10. For example, edge 27 may include a shoulder 28 that may facilitate a close fitting of opening 26 onto opening 16.

According to some embodiments of the present disclosure, openings 21a and 21b of cups 20a and 20b may be attached, for example, such that cups 20a and 20b form a container together. For example, edges 23a and 23b of cups 20a and 20b have forms that facilitate fitting of openings 21a and 21b on each other. In some embodiments, ingredient container 80 may be packed and/or contained within a space created within cups 20a and 20b, for example when cups 20a and 20b are attached, thus define a space and/or form a container together. In some embodiments, stove burner 60 may be packed and/or contained within cup 20, for example when opening 26 is assembled on opening 16.

Ingredient container 80 may include one or multiple cells 82, each may contain an ingredient such as coffee powder or granules, tea mixture, sugar, salt, pepper, spices, soup powder, instant food mixture, etc. Ingredient container 80 may include a cap 84 that may be removably attached on container 80 and/or seal container 80. It will be appreciated that the container/space formed by cups 20a and 20b may contain, in addition or alternatively to ingredient container 80, other containers and/or cooking equipment. For example, in some embodiments, kit 100 may include a fuel container that may be packed together with and/or instead of container 80. In some embodiments, the fuel is contained in stove burner 60. It will be appreciated that the fuel may be or include alcohol. Although the figures show container 80 that fills almost the entire space created by cups 20a and 20b, the disclosure is not limited in this respect. For example, multiple containers may be packed in the space formed by cups 20a and 20b.

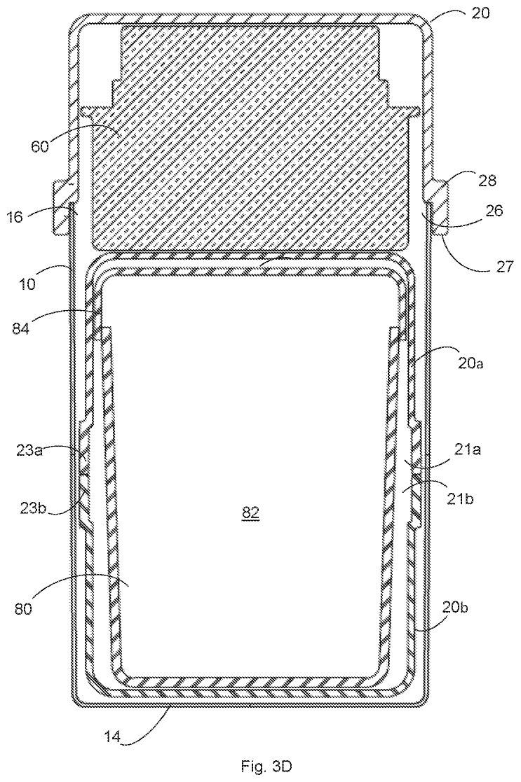

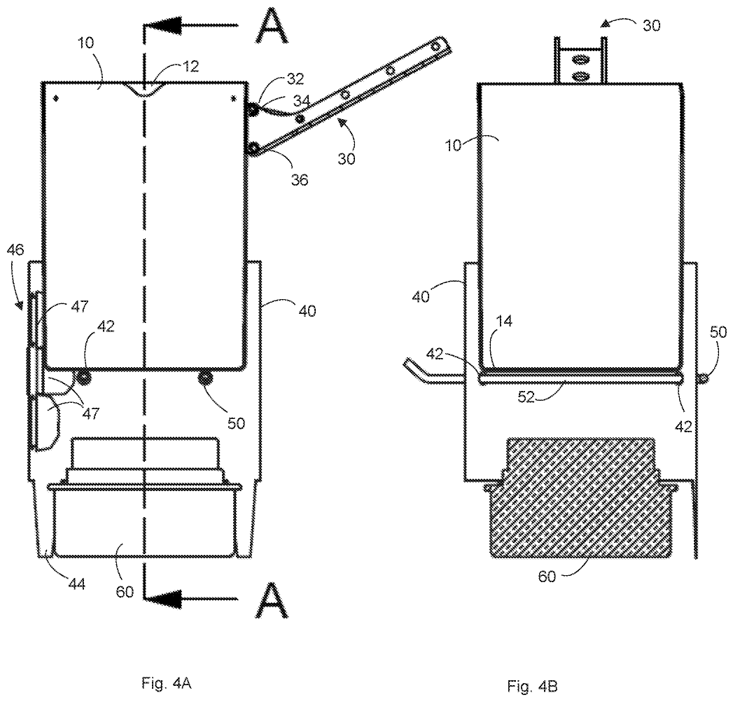

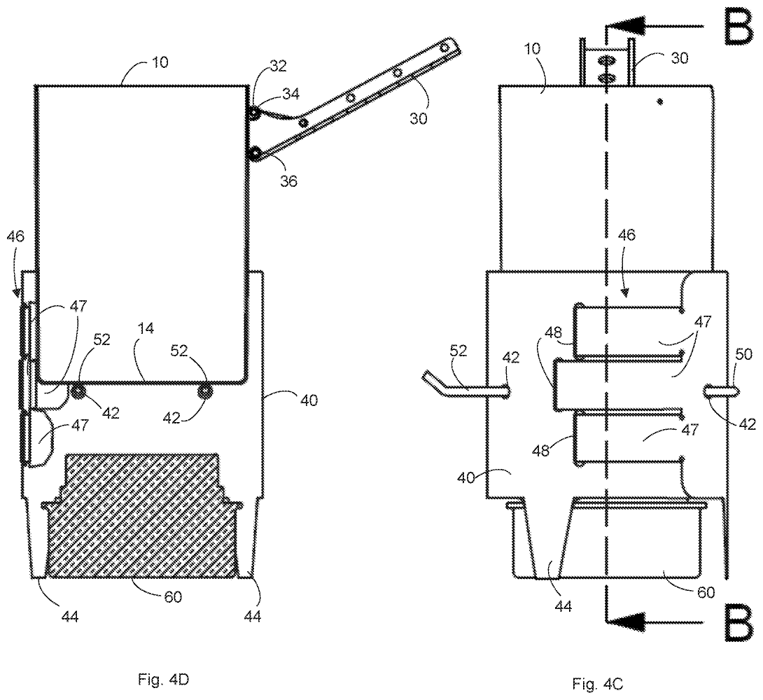

Reference is now made to FIGS. 4A, 4B, 4C and 4D, which are schematic illustrations of side views and cross-sectional views of cooking kit 100 in its cooking state, according to some embodiments of the present disclosure. FIG. 4B shows the cross-section A-A of kit 100 along line A-A shown in FIG. 4A. FIG. 4D shows the cross-section B-B of kit 100 along line B-B shown in FIG. 4C.

Windscreen 40 may be a tube-shaped object and/or with adjustable diameter and/or size. Diameter-adjusting mechanism 46 may include a plurality of straps 47 extending from windscreen 40 and may be inserted into corresponding slits 48 in windscreen 40. In some embodiments of the present disclosure, the diameter and/or size of windscreen 40 may be changed, e.g. reduced and enlarged, for example, by pushing and pulling straps 47 into and from slits 48, respectively. to enable comfortable insertion of a stove burner 60 below pot 10 for cooking, for example without windscreen 40 touching burner 60 and/or pot 10 while burner 60 is operating. Pot support 50 may be fork-shaped and/or u-shaped, with at least two prongs 52. Prongs 52 may be inserted in corresponding holes 42 that enable, for example, insertion of each prong 52 from one side of windscreen 40 and exit of a distal end of prong 52 from another side of windscreen 40. Accordingly, for example, windscreen 40 may include at least four holes 42, two for insertion and two for exit.

In operative state, for example when kit 100 is ready for cooking and/or while cooking, pot 10 may be put within windscreen 40 and/or bottom 14 of pot 10 may be put on and/or be supported by prongs 52. As explained herein, burner 60 may be put within windscreen 40 and/or below pot support 50 and/or bottom 14 of pot 10. Windscreen 40 may include legs 44, for example at least three legs 44 that may enable stable positioning of windscreen 40 on top of a ground, a table or any other suitable surface. The locations of holes 42 along windscreen 40 may be designated to facilitate and/or maintain a desired constant distance between burner 60 and bottom 14 of pot 10, when bottom 14 is on top of pot support 50 and burner 60 is below pot support 50.

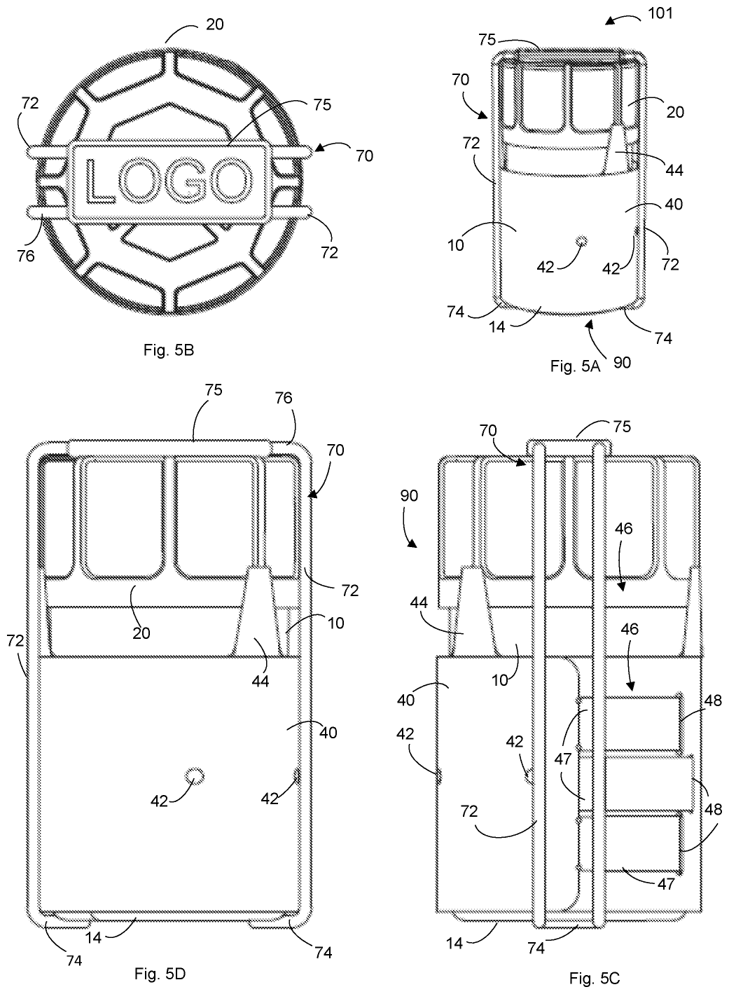

Reference is now made to FIGS. 5A-5D, which are schematic illustrations of perspective, lateral and top external views of a cooking kit 101 in its packed state, according to some embodiments of the present disclosure. Cooking kit 101, similarly to kit 100 described above, may include a cooking pot 10, a cup 20 and a windscreen 40. In its packed state, cooking pot 10, cup 20 and windscreen 40 may form an assembly 90 packed together, as described herein. In assembly 90, pot 10 may be used as a container of kit 101 and cup 20 may be used as a cap, for example, on top of pot 10, wherein other cooking equipment of kit 101 is packaged inside pot 10 and/or cup 20, and/or windscreen 40 may be wrapped about the outer circumference of pot 10 and/or cup 20. Pot 10 may have a bottom 14, for example on a side of pot 14 distant from cup 20 when kit 100 in its packed state. Additionally, kit 101 may a pot carrier/kit holder 70.

Pot carrier/kit holder 70 may include a top stripe 76 that may include a handhold 75. Further, pot carrier/kit holder 70 may include at least two elongated arms 72 extending substantially perpendicularly from sides of top stripe 76. Top stripe 76 may have a length fitting closely to the diameter of cup 20, and/or arms 72, when top stripe 76 is on top of cup 20, may fit closely over sides of assembly 90, for example when kit 101 is in its packed state. Further, elongated arms 72 may include bottom latches 74 inwardly extending towards each other, which may latch arms 72 and/or holder 70 onto assembly 90, for example when kit 101 is in its packed state. For example, holder 70 may hold assembly 90 tightly when latches 74 are inserted below assembly 90 with top stripe 76 on top of assembly 90, as shown in FIGS. 5A-5D. Arms 72 may have a length corresponding to the length of assembly 90, for example a length suitable for fitting closely to assembly 90. For example, when top stripe 76 is closely on top of cup 20, and latches 74 are inserted below assembly 90. As described in more detail herein below, when kit 101 is in cooking state, pot carrier/kit holder 70 may be installed on pot 10 as a carrier, enabling holding and/or carrying of pot 10, for example instead of handle 30.

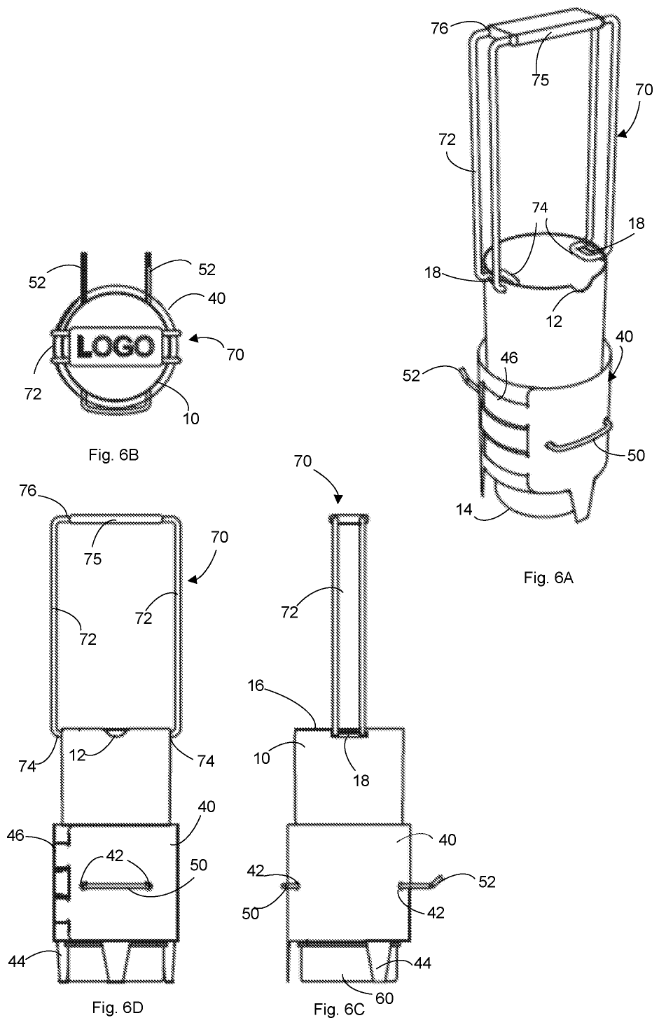

Reference is now made to FIGS. 6A-6D, which are schematic illustrations of perspective, lateral and top external views, respectively, of a cooking kit 101 in its cooking state, according to some embodiments of the present disclosure. For example, after cup 20 was removed from pot 10 and/or other equipment was removed from within pot 10 and/or other operations was performed as described in more detail herein.

Pot 10 may include slots 18, into which latches 74 may be inserted, for example so that pot carrier 70 may extend above pot 10 and/or may be used to carry pot 10. For example, slots 18 may be located at the top portion of pot 10. For example, a user may hold carrier 70 by handhold 75 and carry pot 10 by carrier 70, for example to put pot 10 on pot support 50 and/or to remove pot 10 from windscreen 40. Arms 72 may preferably be long enough in order to enable a user to move pot 10 without being damaged by heat provided by burner 60. However, in order to keep kit 100 compact in its packed state shown in FIG. 5A, when assembly 90 is in packed state, latches 74 fit tightly on bottom 14 and may not extend further beyond bottom 14.

Windscreen 40 may be a tube-shaped object with adjustable diameter, as described in more detain herein. Thanks to some features of windscreen 40, it may enhance the heat transfer from burner 60 to pot 10 and expedite boiling and/or cooking inside pot 10. Windscreen 40 may keep the heat from burner 60 in the surroundings of pot 10, and may prevent cold air from reducing the heat and/or putting out the flames produced by burner 60.

As described, windscreen 40 may include a diameter-adjusting mechanism 46. The diameter may be adjusted so that the protection provided by windscreen 40 will be optimal. The height of windscreen 40, for example including legs 44, may be sufficient to cover the entire height of pot 10 when positioned on top of support 50. Accordingly, windscreen 40 may keep the heat along the entire length and perimeter of pot 10, and/or the heat provided by burner 60 may spread along the entire length and perimeter of pot 10, with minimal loss of the heat.

Windscreen 40 may include holes 42, configured to hold pot support 50 as described in detail herein. Accordingly, for example, windscreen 40 may include at least four holes 42, two for insertion and two for exit.

As described herein above, pot 10 may be put within windscreen 40 and/or bottom 14 of pot 10 may be put on top of pot support 50, for example supported by prongs 52. Burner 60 may be put within windscreen 40 and/or below pot support 50 and/or bottom 14 of pot 10. Windscreen 40 may include legs 44, for example at least three legs 44 that may enable stable positioning of windscreen 40 on top of a ground, a table or any other suitable surface. The locations of holes 42 along windscreen 40 may be designated to facilitate and/or maintain a desired constant distance between burner 60 and bottom 14 of pot 10, when bottom 14 is on top of pot support 50 and burner 60 is below pot support 50. In some embodiments, legs 44 include a folding mechanism and/or can be folded. The desired distance should not be too small, because than the flame may be blocked, and should not be too large, because than the heat may drift away.

When kit 101 or 100 is in its cooking position, e.g. as shown in FIGS. 2A and 2B, 4A-4D or 6A to 6D, windscreen 40 blocks the air surrounding pot 10 leaving a small opening through which air can get out from the top of the gap between windscreen 40 and pot 10, for example, while there are larger openings for suction of air by the flame produced by burner 60. When burner 60 is active, the flame causes suction of air mainly through the openings between legs 44, which are the closest openings to burner 60. The heat from the flame spreads in the gap between windscreen 40 and pot 10, causes heating of pot 10 along its entire height and circumference. Hot air than exits from the top side of the gap between windscreen 40 and pot 10, wherein the air exit opening is smaller than the openings between legs 44, through which the air enters. The difference in the opening sizes causes higher air pressure in the gap between windscreen 40 and pot 10, which increases the heat within the gap, thus improving the heat transfer along pot 10 and/or expediting the boiling and/or cooking within pot 10. This is in contrast to regular field burner apparatuses, which heat the pot only from below.

According to some embodiments of the present disclosure, the material of which pot 10 is made may be a good heat conductor and light-weight, such as aluminum or titanium, for example an 1100 aluminum alloy, and/or the thickness of pot 10 may be suitable for efficient heat conduction. For example, the thickness of pot 10 may be of about 1 millimeter, for example between 0.7 to 1.3 millimeters. Windscreen 40 may be made of thin springy steel, for example of between 0.2 to 0.3 millimeters, for example of 0.25 millimeters, for example so that windscreen 40 can cool down quickly.

It will be appreciated that according to some embodiments of the present disclosure, all the components of kit 100 or kit 101 are designed to be packed together with minimal redundant gaps, as described in detail above, for example, with reference to FIGS. 1A and 1B and 3A-3D. Thus, for example, when packed together, the components of the kit are highly protected against bumps and hits. As described in detail herein, kit 100 and/or 101 includes especially designed cooking equipment enabling compact and light-weight packaging. In some embodiments of the present disclosure, the total weight of kit 100/101 is less than 1000 grams, for example about 500 grams.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprising”, “including” and/or “having” and other conjugations of these terms, when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A cooking kit comprising:
a burner, for producing a flame;
a cooking pot, for cooking foods or beverages;
at least on cup, for consuming said cooked foods or beverages;
a windscreen, wrapped about the outer circumference of said pot, for keeping the heat along the entire length and perimeter of said pot; and
wherein said windscreen is designated to facilitate and maintain a desired constant distance between said burner and the bottom of said of for enhancing the heat transfer from said burner to said pot and expediting the cooking inside said pot.

2. The cooking kit of claim 1, wherein the windscreen blocks the air surrounding the pot leaving a small opening through which air can get out from the top while there are larger openings for suction of air by the flame produced by burner.

3. (canceled)

4. (canceled)

5. (canceled)

6. (canceled)

7. (canceled)

8. (canceled)

9. (canceled)

10. (canceled)

11. (canceled)

12. The cooking kit of claim 1, wherein the pot is adapted to be inserted within the windscreen, wherein a burner is insertable below the pot for maintaining a desired constant distance between the burner and the bottom of the pot.

13. (canceled)

14. (canceled)

15. The cooking kit of claim 1, comprising at least two additional cups adapted to be attached at their openings and to form a container, when attached, the formed container is insertable into the pot.

16. The cook ng kit of claim 15, comprising at least one ingredients container, adapted to be packed in the container formed by the additional cups.

17. (canceled)

18. (canceled)

19. (canceled)

20. (canceled)

21. The cooking kit of claim 1, wherein the pot is made of 1100 aluminum alloy or titanium, and wherein the pot has a thickness of between 0.7 to 1.3 millimeters.

22. (canceled)

23. The cooking kit of claim 1, wherein the total weight of the kit is smaller than 1000 grams.

24. The cooking kit of claim 1, wherein the total weight of the kit is about 500 grams.
